(19) United States
(12) Patent Application Publication
(10) Pub. No.: US 2013/0044927 A1
(43) Pub. Date: Feb. 21, 2013

(54) IMAGE PROCESSING METHOD AND SYSTEM

(71) Applicant: Ian POOLE, Edinburgh (GB)

(72) Inventor: Ian POOLE, Edinburgh (GB)

(21) Appl. No.: 13/210,053

(22) Filed: Aug. 15, 2011

(51) Int. Cl. G06K 9/00

(52) U.S. Cl. 382/131; 382/128

(57) ABSTRACT

A method of detecting the presence of an abnormality in image data, comprises acquiring an image data set representative of an image of a subject, acquiring a statistical atlas representative of normal image data sets obtained from a plurality of reference subjects, comparing the image data to the statistical atlas, and determining the presence of an abnormality by determining a measure of the difference between the image data and the statistical atlas.

### FIELD

Embodiments described herein relate generally to a method and apparatus for detecting the presence of abnormalities in image data, or for generating a statistical atlas representative of normal image data.

### BACKGROUND

The use of such volumetric imaging data in diagnosis of a range of conditions or analysis of a patient's condition is of increasing importance. Diagnosis usually requires review of the image data by a doctor or other trained medical personnel. However, automated methods for identifying and displaying regions of interest, or identifying and highlighting regions that may be abnormal in some way for further review by a doctor, can increase efficiency and speed with which image data can be reviewed. In this context a variety of computer aided detection (CAD) techniques have been developed.

CAD algorithms have been applied to oncology studies, to detect tumours and metastases. They generally work by having specific algorithms segment and classify specific pathologies. For example some known CAD techniques for CT virtual colonoscopy segment the colon lumen and identify polyp-like structures on the colon wall, for example using curvature analysis. Techniques for lung CAD begin by segmenting the lung and then attempt to segment and grade lung nodules. Techniques for mammography CAD searches for clusters of micro-calcifications. However, known anatomy-specific CAD engines require training on abnormal cases, which can be difficult to obtain. Such known anatomy-specific CAD engines also require significant amounts of time and expert input in the training phase, and are also limited very closely to particular anatomical features and to particular types of abnormality.

It is also known to create atlases of the human anatomy, or particular parts of the human anatomy, which can be used in the processing or analysis of image data of a patient. Usually, particular anatomical features identified from the image data are matched to the atlas in a registration procedure. A rigid or non-rigid transformation can be applied to the image data so that the positions of particular anatomical features in the image data are aligned with standard positions for those features defined by the atlas. The use of such atlases and registration procedures enables, for example, direct comparisons to be performed between image data obtained from different subjects.

Known atlases comprise a set of voxels, each voxel comprising image intensity and position data, and may further comprise position data indicating the position of particular anatomical features in the atlas. It has also been suggested to include other statistical measures relating to intensity in an atlas.

Voxel based morphometric (VBM) techniques are used to compare differences in brain anatomy between different patients. Usually image data, comprising per voxel raw intensity as a function of position are mapped to a standard template or atlas, enabling direct comparison between brain images obtained from different subjects.

### BRIEF DESCRIPTION OF THE DRAWINGS

Embodiments are now described, by way of non-limiting example, and are illustrated in the following figures, in which:

FIG. 1 is a schematic diagram of an image data processing system according to an embodiment;

FIG. 2 is a flow chart illustrating in overview an atlas generation process and an abnormality detection process performed by the system of FIG. 1;

FIG. 3 is a flow chart illustrating the atlas generation process of FIG. 2;

FIG. 4 is a schematic diagram showing the overlap of some data sets used in atlas generation;

FIG. 5 is a flow chart illustrating the detection process of FIG. 2; and

FIG. 6 is a plot showing, for a voxel at a single atlas position, the distribution of sample points representative of normal anatomy for that atlas position, together with a selected threshold Mahalonobis distance.

### DETAILED DESCRIPTION

According to one embodiment there is provided a method of detecting the presence of an abnormality in image data, comprising acquiring an image data set representative of an image of a subject acquiring a statistical atlas representative of normal image data sets obtained from a plurality of reference subjects, comparing the image data to the statistical atlas, and determining the presence of an abnormality by determining a measure of the difference between the image data and the statistical atlas.

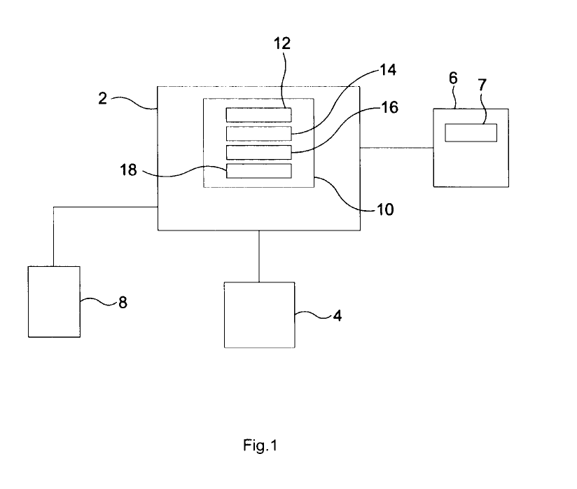

An image processing apparatus according to an embodiment is illustrated schematically in FIG. 1 and is configured to implement the method described in the preceding paragraph. The apparatus comprises a processing apparatus 2, in this case a personal computer (PC) or workstation that is connected to a display device 4, a data store 6 and a user input device or devices 8, in this case a computer keyboard and mouse.

The processing apparatus 2 comprises a central processing unit (CPU) 10 that is operable to load and execute a variety of software modules or other software components. In the embodiment of FIG. 1, the software modules include a texture feature module 12 for determining image texture features from image intensity data. The software modules also include a registration module 14 for matching image data to an atlas, an atlas generation module 16 for generating the atlas from data sets comprising normal image data, and an abnormality detection module 18.

The processing apparatus also includes a hard drive. In the embodiment of FIG. 1 the hard drive stores the atlas that is used in the registration process.

The processing apparatus 2 includes other standard components of a PC including RAM, ROM, a data bus, an operating system including various device drivers, and hardware devices (for example a graphics card) for interfacing with various peripheral devices. Such standard components are not shown in FIG. 1 for clarity.

The data store 6 in the embodiment of FIG. 1 includes a database that stores large number of different datasets, for example volumetric datasets representative of three dimensional CT data obtained from CT measurements on patients. In operation a selected dataset 7 is downloaded from the server to the processing apparatus for processing. The data store 6 in the embodiment of FIG. 1 is a server that stores a large quantity of patient data, and may form part of a Picture Archiving and Communication System (PACS). In other embodiments, the dataset 7 is stored in memory of the processing apparatus 2 rather then being downloaded from the server.

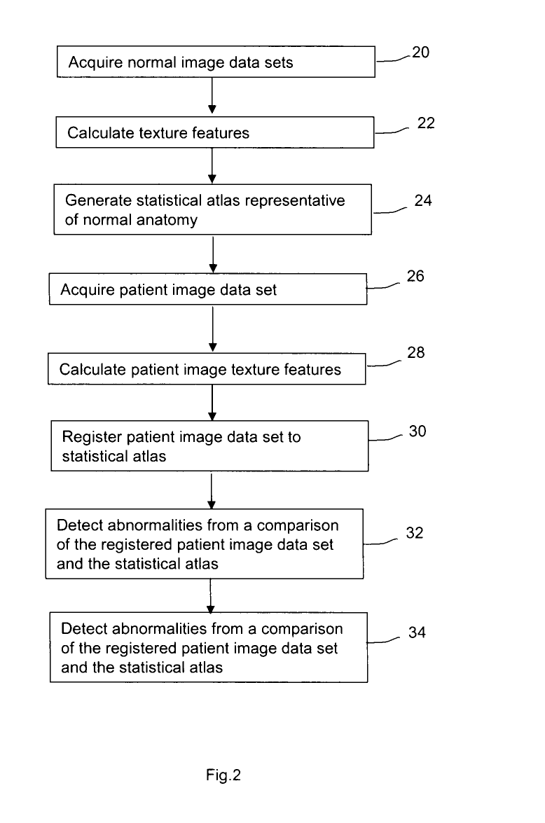

The system of FIG. 1 is configured to perform a sequence of processes as illustrated in overview in the flow chart of FIG. 2. At the first stage 20, apparatus 2 acquires from the data store 6 image data sets obtained from a plurality of patients, comprising voxels (or pixels) that represent image intensity as a function of position. Each of the image data sets is representative of, or is processed by the apparatus to be representative of, image data from normal patient anatomy. Each of the image data sets is then further processed by the texture feature module 12 at stage 22 to calculate image texture features associated with each voxel, and each data set is updated to include the calculated image texture features. At the next stage 24, the atlas generation module 16, and the registration module 14, co-operate to generate a statistical atlas representative of a normal subject anatomy from the plurality of image data sets.

The statistical atlas can then be used to detect the presence of abnormalities in an image date set obtained from a patient. Thus, at the next stage 26 the image data set from a patient is acquired by the apparatus 2, either from the data store 6 or directly from an imaging apparatus, for example a CT scanner (not shown in FIG. 1). Next, 28 the texture feature module 12 calculates image texture features associated with each voxel of the patient image data set. The patient image data set is updated to include the calculated image texture features. At the next stage, 30, the abnormality detection module 18 and the registration module 14 co-operate to register the patient image data set to the statistical atlas. The abnormality detection module 18 then, at stage 32 compares the patient image data set to the atlas to detect any voxels that have greater than a selected likelihood of being abnormal. Finally, at stage 34, the apparatus 2 displays the patient image, highlighting voxels that have been detected as being abnormal.

In the embodiment of FIG. 1, certain processes are performed both in the generation of the atlas and in the subsequent detection of abnormalities in the patient data set. These processes include:
1. Texture feature measurement
2. Inter-patient registration
3. Probabilistic distance computation, based on multivariate Gaussian distributions.

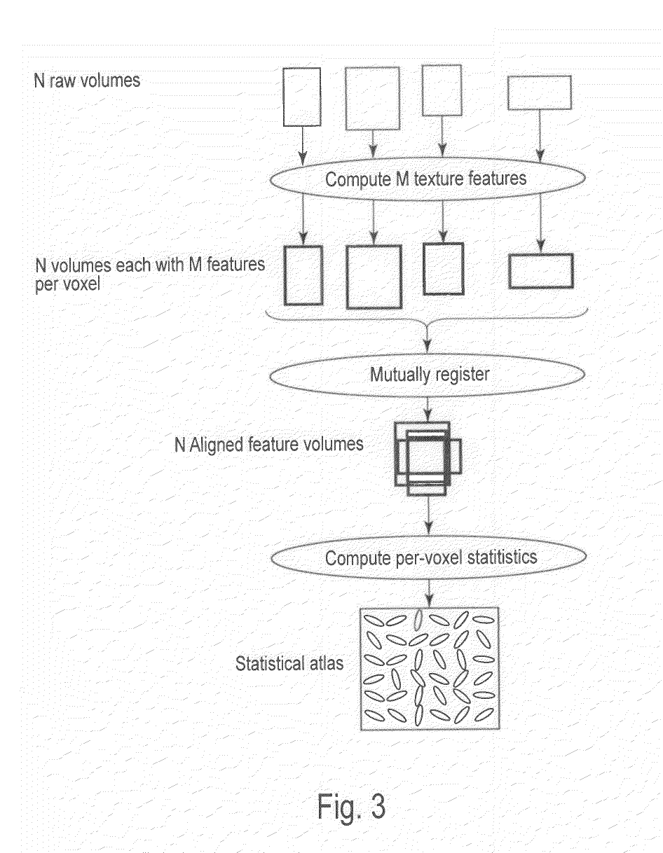

Each of the stages of the process illustrated in FIG. 2 are now considered in more detail. The stages relating to the generation of the statistical atlas can also be referred to as training stages or a training phase. A flow chart illustrating aspects of the training phase in more detail is provided in FIG. 3.

At the first stage 20, normal image data sets are acquired. The imaging modality and anatomical region of interest, are selected and a sufficiently large number N (for example, N=100) of image datasets from normal individuals are selected and acquired from the data store 6.

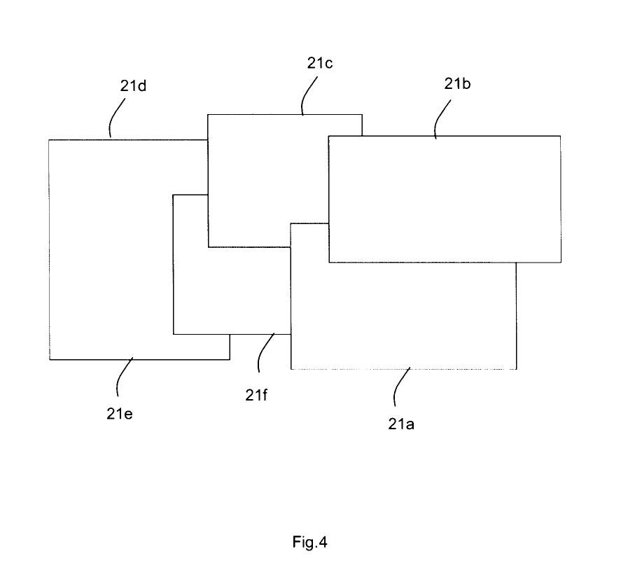

For modalities such as computed tomography (CT) which have x-ray dose implications, entirely normal datasets can be hard to find and so it is likely that the datasets used for training will include abnormal regions. Datasets for such modalities can be reviewed by an operator and any areas of abnormality selected out leaving only image data representative of normal anatomy. Accurate segmentation is not required since the selected abnormal areas are not used in generation of the atlas. In many cases, no one data set will cover the entire volume under consideration for which a statistical atlas is to be generated. Usually a selection of different datasets 21a, 21b, 21c, 21d, 21e, 21f is used each of which only covers a part of the volume, but which together cover the whole volume, as illustrated schematically in FIG. 4.

At the next stage 22, texture features are calculated by the texture feature module 12 for each voxel of each normal image dataset. For example, a variety of texture-like features can be calculated based on image values in a local neighbourhood. Possible features include (but are not limited to):
gradient magnitude at multiple scales
gradient vector at multiple scales (for example, x,y,z gradient components)
statistics from co-occurance matrices
features based on a wavelet transformation of the intensity in the neighbourhood of the voxel, for example Haar texture features

The texture features can be computed directly on input volumes, which in general will be at differing scales (mm/pixel) for each of the N normal data sets. Thus it is important that spatial parameters of the texture features (such as the Gaussian kernel size used to compute gradients) are specified in millimetres not pixels.

There are several tens of possible texture features or other image features that can be used. The most appropriate features for atlas generation or abnormality detection for a particular data set or anatomy can be selected as discussed in more detail below. In the foregoing analysis, M texture or other features are provided for each voxel. Thus, for each voxel i in each volume n a feature vector x_{n,i} is calculated, each feature vector having size M.

At the next stage 24 the statistical atlas is generated from the normal data sets, also referred to as training data sets. In order to generate the atlas the N data sets are mutually aligned (by rigid and non-rigid registration).

Multiple features (for example, texture features) are available at each voxel i. The statistical atlas maintains at each voxel i an M×1 mean vector μᵢ and M×M covariance matrix Σᵢ, estimated from the Nᵢ samples which have been mutually aligned (by rigid and non-rigid registration) at that atlas position. In some cases Nᵢ may be less than N (the total number of training volumes) since not all of the volumes covered by the data sets may overlap at that point and/or some voxels may have been masked out as abnormal. When Nᵢ is small, for example if Nᵢ<M, then Σᵢ may be singular and thus non-invertible. When this happens, covariance weighting can be used or Σᵢ can be replaced by Σ_{global} which is estimated over the entire volume. Thus a multivariate Gaussian model of the aligned volume features is maintained for each atlas voxel.

To create the statistical atlas, the N training datasets must be brought into mutual alignment. That is, for each dataset k, k=1 . . . N a transformation Tk, Tk: R³→R³ is calculated which maps coordinates in k onto a common atlas coordinate system. There are a number of ways this can be achieved, involving both rigid and non-rigid registration. Two variants are now outlined for determining the transformation, although any suitable method may be used.

The method of the first variant iteratively aligns each training volume to progressively generate a statistical atlas, S. The method comprises two loops. In the first loop, the statistical atlas S is taken, as a starting point, to be identical to any one of the training datasets k₁. Each of the other data sets is registered to the statistical atlas in turn, and after each data set has been registered to the data set the statistical atlas is update to include that transformed data set. In the embodiment of FIG. 2, the statistical atlas maintains at each voxel an M×1 mean vector μᵢ and M×M covariance matrix Σᵢ as mentioned above, estimated from the data sets that have been aligned. The number of data sets contributing to the mean vector and covariance matrix increases one-by-one, until all data sets have been registered and included in the atlas S. The first loop can be represented as follows:

S=k₁

for n=2 to N
Tₙ←Register kₙ to S
S←Add Tn (kₙ) to S

A second loop is then performed in which each of the data sets k is again registered to the atlas S generated using the first loop and, for each data set k, the atlas S is updated with the transformed data set. It will be understood that, as the atlas S, will have been updated since the data set was mapped to the atlas during the first loop, the transformation to map the data set to the atlas will, in most cases, be slightly different than the transformation for that data set during the first loop. The second loop can be represented as follows:

for n=1 to N
Tₙ←Register Iₙ to S
S←Replace Tn (kₙ) in S
   The second loop can be repeated several times if desired, for example until the atlas converges within an acceptable level of variation.

In the embodiment of FIG. 2, registration of a data set to the atlas is performed in a maximum likelihood framework, by minimizing Mahalanobis distance. For any candidate alignment of a data set kᵢ with the statistical atlas S, it is possible to compute a Mahalanobis distance at each voxel, based on the mean and covariance matrix at that voxel:

Dᵢ=((xᵢ−μᵢ)′Σ⁻¹(xᵢ−μᵢ))^{1 2}

where xᵢ is the feature vector at voxel i of the floating volume.

Intuitively, Dᵢ represents how statistically different is xᵢ from the samples seen in the atlas. Dᵢ forms the similarity measure. In the univariate case (M=1), Dᵢ reduces to the number of standard deviations from the mean.

Whatever similarity method is used, registration according to the embodiment of FIG. 2 comprises a rigid registration stage followed by a non-rigid registration stage. Rigid registration involves optimizing the mean per-voxel similarity, given 9 rigid transformation parameters (3 translation, 3 scale, 3 rotation). Powell minimization is used in the embodiment of FIG. 2, but any suitable optimisation can be used in alternative embodiments.

The non-rigid phase requires local optimization of the similarity measure. In the embodiment of FIG. 2, a dense field framework similar to that described in WR Crum et al, Information Theoretic Similarity Measures in Non-Rigid Registration, Lecture Notes in Computer Science, 2003 is used. In brief, ‘forces’ on the warp field are computed from gradients in the similarity measure, the gradients being calculated numerically, by central difference. Regularization of the warp field is achieved by a Gaussian smoothing function applied to the force field before being added into a cumulative warp field which is also smoothed. This process is iterated to convergence. The two stages of smoothing respectively implement a form of ‘viscous fluid’ and ‘elastic body’ constraint on the complexity of the warp field, and ensure that it remains invertible.

Before considering the use in the detection of abnormalities of the statistical atlas S representative of normal anatomy, an alternative method of creating the statistical atlas is described.

The alternative method of constructing the statistical atlas uses a more conventional registration approach. Again, it is assumed that M features (for example, texture features) are available at each voxel. One of the N data sets is selected as reference. The remaining N-1 data sets are each aligned with the reference using any registration strategy appropriate to inter-patient registration for the given modality. This will usually involve a rigid registration phase (translation, scale and rotations) and non-rigid registration phase. A mutual information technique is used to determine the measure that is optimised during the registration procedures.

Mutual information (MI) is commonly computed via a joint histogram. However, this is not practical for multivariate inputs as here (due to texture features), thus a more computationally convenient similarity of MI by covariance method is used

Although the above MI method provides an alternative method of determining the statistical atlas, it has been found that the first method based on registration to the atlas by Mahalanobis distance can in practice provide additional advantages compared to the MI method.

For example, since MI is computed globally across the volume, it is insensitive to variation in intensity relationships in different anatomies whereas the Mahalanobis distance method is sensitive to such variations. In addition, the MI method can deliver an accurate transformation (for example, including both rigid and non-rigid stages) only in the region of the volume covered by the selected reference data set, and it may not be possible to find a reference data set covering a sufficiently large volume to cover the union of all available training volumes. In contrast the Mahalanobis distance method can provide an accurate transformation across all regions covered by the training data sets. Furthermore, the MI method requires an arbitrary selection of the dataset to use for the reference.

Regardless of which atlas generation method is used, the final stage of the training phase comprises obtaining the mean and inverted covariance matrices, μᵢ and Σᵢ⁻¹ for each atlas voxel, based on the up to N available data sets. A further advantage of the method involving minimization of Mahalanobis distance method, is that the mean and covariance matrices have already been obtained as part of the atlas generation method, thus in some cases reducing the computational burden and processing time. In contrast, for the MI method a further significant processing step is required to calculate the mean and covariance matrices.

The statistical atlas S can subsequently be used for any desired purpose. For example, the atlas or any selected data from the atlas can be displayed to a user if so desired. The statistical atlas S is representative of a normal anatomy, determined from a large number of subjects, and represents image intensity data for such a normal anatomy, a variety of image texture features, and also the variation of such intensity or texture features between subjects. As such, the statistical atlas can be useful for a variety of diagnostic purposes, for use as a reference, or for training of medical or other personnel.

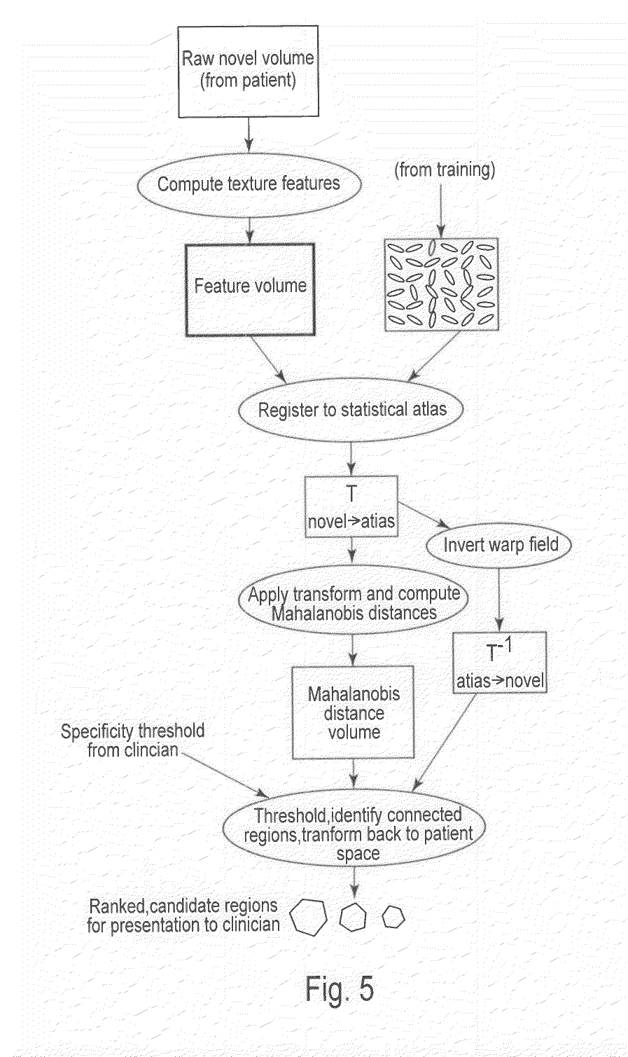

One particularly valuable use for the statistical atlas representative of normal anatomy is in the detection of abnormalities in an image data set obtained from a patient or other subject, as described briefly above in relation to FIG. 2. Further description of such abnormality detection is now provided. A flow chart illustrating the detection phase schematically in more detail is provided in FIG. 5.

At the first stage 26 of the detection phase, an image data set from a patient is acquired and at stage 28 the texture feature module 12 calculates image texture features for each voxel of the patient image data set. The same texture features are calculated as were calculated for the training data sets for generation of the statistical atlas. The patient image data set is then updated with the calculated image texture features.

At the next stage, 30, the patient image data set is registered to the statistical atlas S. The registration process is performed by the registration module 14 and involves rigid and non-rigid registration stages and, again, is based on minimization, for each voxel, of Mahalanobis distance between the voxels of the patient image data set and the voxels of the statistical atlas S. The registration process for registering the patient image data to the statistical atlas is the same or similar to that used to register individual training data sets to the statistical atlas during generation of the statistical atlas.

The registration process results in a transformation T: R³→R³ mapping a coordinate j in the volume represented by the patient image data set to the corresponding atlas coordinate i.

At the next stage 32 the abnormality detection module 18 compares the registered patient image data set to the atlas to detect any voxels that have a greater than a selected likelihood of being abnormal. The abnormality detection stage 34 comprises a series of processes as follows:

For every voxel j in the patient image dataset:
(a) identify the corresponding point i=T(j) in atlas space, thus selecting the mean and covariance matrices, μᵢ and Σᵢ⁻¹;
(b) determine the Mahalanobis distance Dⱼ between xⱼ and the distribution represented by μᵢ and Σᵢ⁻¹;
(c) determine the probability of seeing this or a more dissimilar observation (otherwise referred to as the outlier probability);
(d) determine whether the outlier probability for the voxel is greater than a selected threshold. If the outlier probability is greater than the threshold, then the voxel is indicated as representing a possible abnormality.

In the embodiment of FIG. 2, the outlier probability for each point is determined using Hotelling's T² statistic, which is a multi-dimensional generalization of the univariate t-test. For the case of testing a single M-dimensional sample against a distribution estimated from a sufficiently large sample, the probability reduces to a χ² function of the Mahalanobis distance squared, Dⱼ², with M degrees of freedom. Thus the threshold on Mahalanobis distance can be set given M and the chosen false positive operating threshold. The false positive operating threshold is selected by an operator in some embodiments.

If a high false positive operating threshold is selected then more points representing possible abnormalities may be detected by the process, but there will be a greater chance that some of them will not in fact represent abnormalities. If a low false positive operating threshold is selected then fewer points representing possible abnormalities may be detected by the process, but there will be a greater chance that all of the points will in fact represent abnormalities

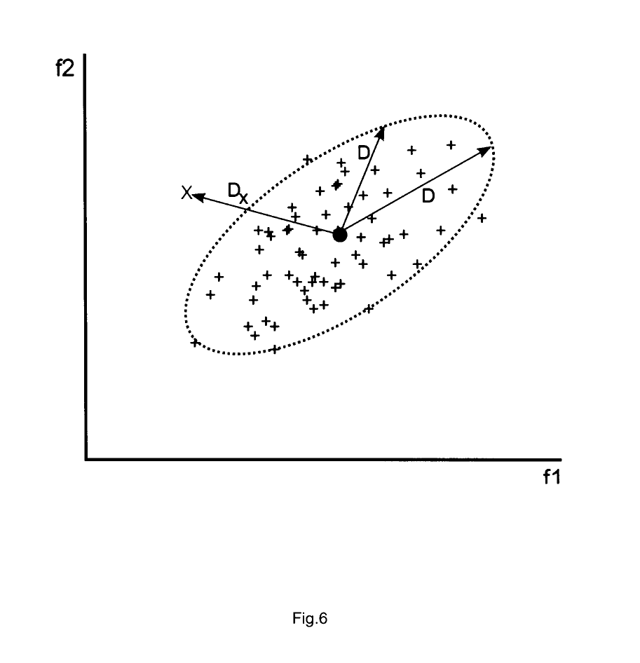

The selected threshold defines ellipsoids in feature space representing ‘normality’ as illustrated in FIG. 6. FIG. 6 shows the feature space for a single atlas position. Sample points from the training data sets representing normal anatomy for the atlas position are shown as + signs. The dotted line represents a contour of equal Mahalonobis distance of selected threshold value D. A feature vector measured for a corresponding voxel in a patient image data set is show by an X. In this case it can be seen that the point X has a Mahalanobis distance Dₓ greater than the selected threshold Mahalanobis distance D, and the voxel would therefore be identified as potentially representing an abnormality.

Processes (a) to (d) are repeated for each voxel in the patient image data set, resulting in a set of voxels that have been detected as potentially representing abnormalities. The detected voxels form a disconnected domain in atlas space. In some embodiments, connected component analysis is performed, for example using a disjoint sets algorithm or any other suitable method. Alternatively, Markov smoothing is applied in order to suppress responses from isolated voxels. This results in zero or more candidate regions of abnormality. At the user's option, regions containing fewer than a user defined threshold number of points can be suppressed.

Candidate regions of abnormality are mapped back to the space of the novel patient dataset by applying the inverse transformation T⁻¹. The patient image data set is then updated with indicators associated with some of the voxels indicating that they may be representative of abnormalities.

The patient image data set can then by displayed to an operator, and the locations identified as representing abnormalities can be highlighted to a user. Any suitable method of highlighting the locations of abnormalities can be used. For example, abnormal locations can be presented in a different colour (for instance, red) or more brightly than other locations, or lines can be drawn around abnormal regions. In one mode of operation, candidate abnormal regions are presented to the user in order of size or summed Mahalanobis distance within the region (largest first), by scrolling to the relevant 2D image with the candidate region outlined with a rectangle. Any other suitable method of presentation can be used.

In one embodiment an operator interface is provided which includes a slider that can be used by an operator to select the false positive operating threshold. The patient image data set is displayed, and as the operator slides the slider to select a lower or higher threshold, more or fewer locations are highlighted on the displayed image as representing candidate abnormal regions. That can provide a particularly useful way of displaying potential regions of abnormality and for providing operator control over the false positive rate.

The described embodiment is able to identify a broad spectrum of abnormalities, at a voxel level, in medical datasets, and thus provides a form of computer aided detection (CAD) based on texture features, inter-patient registration and probabilistic distance measures. For a chosen imaging modality and anatomical region (potentially the whole body) the embodiment can highlight connected voxels having a high probability of being abnormal in some way. The system is fully automatic and might reasonably take a few minutes for a typical dataset on current hardware. A particular value of the method of the described embodiments is in the generality of abnormalities which can be detected, and the requirement of only normal datasets for training. The embodiments takes the approach of considering the CAD problem as one of detecting outliers from normal distributions. It thus becomes an unsupervised pattern recognition problem, for which only normal datasets are required, with no specific ground-truth. Therefore, little if any expert input is required during the training phase, other than in selecting data sets that represent normal anatomy.

A strength of the described embodiments is that, in effect, a classifier is trained specifically for each anatomical region. This includes the edges or interfaces of structures, which will typically have very different texture characteristics. That is only the case if the registration algorithm is effective. In highly complex/variable parts of the body—such as the bowel—registration may be more unreliable. However, a further strength of the method is that it naturally adapts (reduces) its sensitivity in these regions, keeping its specificity constant. Where registration is inaccurate—such as the bowel, or small vessels—the correspondence to atlas space will be chaotic, and so the measured distributions will have a large spread. Thus, measured Mahalanobis distances will typically be small, so false positive signals will be no higher than elsewhere.

Specificity can be controlled by the threshold, and in principle at least the threshold is directly related to specificity; it is not just an arbitrary, uncalibrated scale. On the other hand, sensitivity for any particular pathology can only be determined by an appropriate trial against ground truth—as for any CAD system. Thus one can set specificity, but sensitivity varies in an unknown inverse relation. As the registration algorithm, or feature measurement improves then so the sensitivity improves (following retraining) for a given setting of specificity.

It may be that some known anatomy-specific supervised algorithms that are dedicated to a particular anatomical feature and that are based on training sets of abnormal data for that particular anatomical feature (for example, heart, liver, kidney) together with operation by trained medical personnel may ultimately be more accurate in detecting the presence or absence of abnormalities for that particular feature. However, a particular strength of the described embodiments is that they can be used to detect rapidly many different types of abnormalities in any type of anatomical feature, and flag up a patient or image data set as requiring further attention or diagnostic analysis. If necessary, further anatomy-specific supervised algorithms could be applied to selected parts of the data that have been indicated as potentially representing abnormalities by the described embodiments.

The method can also be used an aid to reporting incidental findings. For instance if a CT or other scan was being performed on a patient for another purpose, for example to view in detail a particular part of the patient's anatomy, image data that was obtained could also be compared to the statistical atlas, as a routine background check, to determine if any abnormalities were present in the image data. The method can be used in situations where a radiologist is not the first reviewer of the image data, for example in trauma imaging, or in CT coronary angiography performed by a cardiologist.

Examples of abnormalities that can be detected accurately using the described embodiments include, but are not limited to, aneurysms, calcification or high grade stenoses in large arteries, high-grade tumours in the lung, liver or brain, some congenital abnormalities, sites of previous surgery (for example a resected kidney), significant bone fractures, organ atrophy (for example of the brain) and other signs of chronic disease progression (for example, bone degeneration, cardiac enlargement due to left ventricle failure), or components of differential diagnosis of disease processes with complex and diffuse image findings.

The method requires determination of several features for each voxel, on which the multivariate analysis is performed. As mentioned above, there are many possible features, for instance many tens of image texture features, that can be used. For reasons of storage efficiency, and more importantly to avoid statistical over fitting, a limited number of features are used. Feature selection can in principle be performed independently for each reference atlas voxel. However, for efficiency reasons the same feature set is usually used for each voxel in the atlas. That avoids the need to store feature identifiers for each voxel, and allows efficient computation of features.

Since we are using the up to N data sets to estimate an M×1 mean vector and an M×M (symmetric) covariance matrix we have M+M(M+1)/2 parameters per voxel. For example, if M=4 this results in 14 features so around 150 samples would be required for reliable estimation (following a rule of thumb, or 10 samples for each estimated parameter). Feature selection is a well studied topic. In the present case it is desired to select features so as to minimize the statistical overlap between atlas voxels, so as to have the greatest power to discriminate anatomical location, and by extension, pathology.

An alternative to feature selection is to compute a large number L of features and then reduce dimensionality to M orthogonal features by principle component analysis. This requires a M×L projection matrix to be stored for each reference atlas voxel. All L features must be computed in use, thus costing computation time, but it is possible that greater accuracy or sensitivity may be obtained in some cases.

As with all trained algorithms, accuracy improves the more restricted is the data on which it is trained and used. Thus, statistical atlases can be specialized for gender, age range or ethnicity. Specialization to a specific scanner model (e.g. the Aquilion One) so that the training data sets and the patient image data set are all obtained using the same scanner model, can also be beneficial. The training process is automatic, and only normal datasets are required, so such specialization is feasible. Selection of meta-parameters over which to specialize can be made by an operator at run time. However, there is a trade-off between the reduction in statistical bias achieved by specialization and the increase in variance (over-fitting) resulting from the reduced size training set.

Where meta-data has ordinal values—such as age or weight—these can be incorporated as additional features, common to all voxels of a dataset, thus avoiding the need to form discrete sub-sets.

Each of the N data sets which contribute to the statistical atlas will in general cover different anatomical regions and be acquired at different spatial scales. Further, the voxels will not in general be cubic. Thus there is no obvious resolution over which the atlas should be stored. In choosing the scale (i.e. resolution) of the statistical atlas, one needs to consider the required volume of data storage and the danger of over-fitting.

Assuming M features are explicitly selected (rather than using principle component analysis), a mean vector and inverted covariance matrix is required to be stored for every voxel in the statistical atlas. The anatomical region under consideration might cover, say 300 mm×300 mm×300 mm. An atlas resolution of say 5 mm results in 60³=216,000 atlas voxels, which is manageable. A typical dataset might be acquired at resolutions of say 1 mm per voxel. If we have N=100 training datasets, then there are up to 5³×100=12,500 (albeit partially correlated) raw voxels contributing to each atlas voxel. Thus over fitting should not an issue.

Regardless of the choice of atlas scale, computation of texture features and the resulting Mahalanobis distance is performed for every raw dataset voxel at full scale. Thus the parameter reduction described here is not equivalent to down sampling the original data; fine detail remains visible through the texture features. Model parameters can be obtained for sub-voxel locations by interpolation. In the case of the covariance matrix, interpolation can be performed in a log-Euclidean fashion.

The embodiment of FIG. 2 has been described in relation to the automatic detection of abnormalities in a patient image data set. A related application is to assist a clinician (possibly a trainee) in making an assessment of whether a patient image is normal or abnormal by eye, by presenting examples of images of normal anatomy on any user selected view. For example, having selected a particular MPR (possibly oblique) view in order to visualize some suspicious morphology in the spine, a “show me normality” tool might replace, for example, a 4 cm×4 cm square of the view with the corresponding data from the training set, with scale and orientation matched to the current dataset.

Furthermore, several examples of normality can be presented (providing the training datasets and registration warp fields are available at run time). The system could select say 5 example images or portions of an image, to be scrolled through upon command of the user via the user interface. Each rendered example image or portion of an image could be rendered to match the rest of the displayed image as described in the previous paragraph. The examples can be selected so as to maximize the spanning of the feature space (texture features having already been measured) so that a small number of examples capture as wide a range of the normal variation as possible.

In the mode of operation described above in relation to FIG. 2, CT image data has been used both for the training data sets and the patient image data set, and the multivariate features used in statistical atlas generation and abnormality detection are CT image texture features. However, any suitable imaging modality can be used, for example PET or MRI. Furthermore, the described embodiments can be used to generate statistical atlases from, or detect abnormalities in, combined multi-modal image data sets.

Such an extension to combined multi-modal datasets, such as PET/CT or multi-sequence MRI can be straightforward. The multi-sequence MRI datasets can include any suitable combination of datasets, for example any suitable combination of T1-weighted, T2-weighted or FLAIR datasets.

The multimodal datasets usually consist of multiple volumes acquired in close succession, such that patient movement is minimal and can be corrected by non-rigid registration. Texture features can then be computed for each volume and augment the pattern vector available at each volume. In the case of PET/CT, while the PET signal is a powerful indicator of tumour growth, it needs to be interpreted in an anatomically specific way, for example the PET signal from the bladder should be ignored. The disclosed method used on combined PET/CT would naturally achieve this with no special rules. For instance, the statistical atlas in respect of the bladder region would show large variations in the PET signal obtained from the bladder region for normal anatomies. Therefore it is likely that the method would not indicate any abnormality in the bladder region based on the PET signal received from the bladder of a patient under investigation, given the wide spread of PET signals from the bladder for normal anatomies (the Mahalanobis distance threshold for the PET signals obtained from the bladder would be very large).

MRI studies are often acquired for multiple sequences. For example multi-sequence acquisitions including both T1 and T2 weighting have been shown to improve discrimination of grey matter (GM), white matter (WM) and cerebral-spinal fluid (CFS) in the brain. Thus, if the features of each voxel used for generation of the statistical atlas are T1 and T2 weighted MRI image features, then abnormal patterns of GM/WM/CSF distribution can be detected. T1 and T2 weighted acquisitions used together have also been shown to discriminate multiple sclerosis lesions.

In the embodiment of FIGS. 1 and 2, the system firstly generates the statistical atlas and then uses the statistical atlas to detect abnormalities. It is more usual for the statistical atlas to be generated in advance and stored, for example in data store 6. The statistical atlas can be then be provided to an image acquisition or processing apparatus for detection of abnormalities in a patient image data set, or for training or other purposes.

The embodiment of FIG. 2 has been described in relation to volumetric image data sets. The described methods can also be used in generation of statistical atlases from two-dimensional data sets, or detection of abnormalities in two-dimensional data sets.

A particularly useful application to two dimensional data sets is in the analysis of scout image data. When performing CT imaging, an initial set of imaging measurements is performed on a patient, often from a single angle or set of angles. The measurements usually comprise X-ray projection measurements on the patient at a fixed angular position of the X-ray source. Such initial measurements are often of relatively low power or resolution. The initial measurements are referred to as scout image measurements, and the resulting image can be referred to as a scout image and is similar to a convention X-ray image. The term scanogram can also be used to refer to the scout image. An operator typically examines the scout image to identify the position of a patient relative to the imaging apparatus, and identify the approximate position of particular anatomical features or regions. The operator then uses that information to set up the imaging apparatus for subsequent more accurate or higher dosage measurements of particular anatomical regions.

In further embodiments, a statistical atlas is generated from CT scout image data sets obtained from normal anatomies. The statistical atlas is stored at a control terminal associated with a CT imaging apparatus. In operation, a scout image is obtained from a patient by the CT imaging apparatus. The scout image is compared to the statistical atlas as described above in relation to FIG. 2 and regions of possible abnormality in the scout image are identified from the comparison. As well as displaying the scout images with the abnormal regions highlighted, the control terminal of the CT imaging apparatus can also automatically determine operating parameters for more detailed measurements on the detected abnormal regions. The more detailed measurements can be suggested to an operator by the terminal, via a user interface. If the operator selects the more detailed measurements, then the control terminal proceeds with the measurements using the automatically determined operating parameters.

The Mahalonobis distance has been used as the statistical distance that is used in the generation of the statistical atlas and in the detection of the presence of abnormalities. The Mahalonobis distance can be particularly useful in this context, as discussed, but nevertheless other statistical distances can be used if desired.

Whilst particular modules have been described herein, in alternative embodiments functionality of one or more of those modules can be provided by a single module or other component, or functionality provided by a single module can be provided by two or more modules or other components in combination.

It will also be well understood by persons of ordinary skill in the art that whilst embodiments implement certain functionality by means of software, that functionality could be implemented solely in hardware (for example by means of one or more ASICs (application specific integrated circuit)) or by a mix of hardware and software. As such, embodiments are not limited only to being implemented in software.

While certain embodiments have been described, these embodiments have been presented by way of example only, and are not intended to limit the scope of the inventions. Indeed the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms and modifications as would fall within the scope of the invention.

1. A method of detecting the presence of an abnormality in image data, comprising:
acquiring an image data set representative of an image of a subject
acquiring a statistical atlas representative of normal image data sets obtained from a plurality of reference subjects
comparing the image data to the statistical atlas
determining the presence of an abnormality by determining a measure of the difference between the image data and the statistical atlas.

2. A method according to claim 1, wherein the image data comprises medical image data, the normal image data sets are data sets representative of normal anatomies, and the abnormality comprises an abnormality in the anatomy of the subject.

3. A method according to claim 1, wherein the comparing of the image data to the statistical atlas comprises performing a multivariate comparison.

4. A method according to claim 1, wherein the comparing of the image data to the statistical atlas data comprises determining a measure of statistical distance.

5. A method according to claim 4, wherein the statistical distance comprises the Mahalanobis distance.

6. A method according to claim 1, wherein the statistical atlas is representative of normal image data obtained at a plurality of locations for each reference subject, the statistical atlas comprises a plurality of image parameters for each location and/or the image data set comprises a plurality of image parameters for each location.

7. A method according to claim 6, wherein the plurality of image parameters for a location comprise a measure of image texture at that location.

8. A method according to claim 6, wherein the plurality of image parameters for a location comprises at least one of:—average image intensity; average magnitude of image intensity gradient; average image intensity gradient vector; or wavelet transform features for example Haar texture features.

9. A method according to claim 6, wherein the plurality of parameters for a location comprises a measure of the variation of at least one image parameter at that location across the plurality of reference subjects from which the atlas was generated, for example the variation of at least one of average image intensity; average magnitude of image intensity gradient; or average image intensity gradient vector.

10. A method according to claim 9, wherein the measure of variation comprises variance or standard deviation.

11. A method according to claim 6, wherein the plurality of parameters for a location comprise image parameters obtained for that location using different imaging modalities, for example CT and PET, or T1 and T2 weighted MRI.

12. A method according to claim 1, wherein the method comprises registering the image data set to the statistical atlas using at least one of a rigid registration procedure and a non-rigid registration procedure.

13. A method according to claim 12 as dependent on claim 4, wherein the registering of the image data set comprises minimising the same statistical distance, for example the Mahalanobis distance, as used in the subsequent comparing of the image data of a subject to the statistical atlas.

14. A method according to claim 1, wherein the image data comprises a plurality of pixels or a plurality of voxels, and the comparing comprises comparing each pixel or voxel of the image data set to a corresponding pixel or voxel of the atlas.

15. A method according to claim 14, wherein the method comprises identifying pixels or voxels, or groups of pixels or voxels, of the image data set for which the measure of difference is greater than a selected threshold.

16. A method according to claim 15, wherein the method comprises displaying the image data set, and highlighting the pixels or voxels, or groups of pixels or voxels, for which the measure of difference is greater than the selected threshold.

17. A method according to claim 15, wherein the method comprises receiving user input that selects the threshold.

18. A method according to claim 17, wherein the method comprises providing a user interface that comprises a slider for selecting the threshold.

19. A method according to claim 17, wherein the threshold is representative of an expected false positive rate for the determined presence of an abnormality.

20. A method according to claim 1, wherein the acquisition of the statistical atlas comprises generating the statistical atlas from a plurality of reference data sets, wherein each reference data set is representative of a respective, normal anatomy.

21. A method according to claim 1, wherein the image data set and/or the normal image data sets comprises at least one of MR, PET, CT, or cone beam angiography image data.

22. A method of generating a statistical atlas representative of normal image data, comprising:
acquiring a plurality of sets of image data, each set of image data being from a respective subject and being representative of the image of that subject at a plurality of locations;
determining, for each set of image data, a plurality of image parameters for each location;
performing an atlas mapping procedure for each set of image data, comprising mapping each set of image data to the atlas, and updating the atlas with the mapped image data
wherein for each set of image data the atlas mapping procedure comprises minimising a measure of multivariate statistical distance between the set of image data and the atlas.

23. A method according to claim 22, wherein the multivariate statistical distance comprises a Mahalanobis distance.

24. A method according to claim 22, wherein the generated statistical atlas is subsequently used in a method of detecting the presence of an abnormality according to claim 1.

25. A method according to claim 22, further comprising displaying an image of normal anatomy obtained from the statistical atlas.

26. A system for detecting the presence of an abnormality in image data, comprising a processing resource configured to:
acquire an image data set representative of an image of a subject;
acquire statistical atlas representative of normal image data sets obtained from a plurality of reference subjects;
compare the image data to the statistical atlas; and
determine the presence of an abnormality by determining a measure of the difference between the image data and the statistical atlas.

27. A system for generating a statistical atlas representative of normal image data, comprising a processing resource configured to:
acquire a plurality of sets of image data, each set of image data being from a respective subject and being representative of the image of that subject at a plurality of locations;
determine, for each set of image data, a plurality of image parameters for each location; and
perform an atlas mapping procedure for each set of image data, comprising mapping each set of image data to the atlas, and updating the atlas with the mapped image data,
wherein for each set of image data the atlas mapping procedure comprises minimising a measure of multivariate statistical distance between the set of image data and the atlas.

28. A computer program product comprising computer readable instructions that are executable by a computer to:
acquire an image data set representative of an image of a subject;
acquire statistical atlas representative of normal image data sets obtained from a plurality of reference subjects;
compare the image data to the statistical atlas; and
determine the presence of an abnormality by determining a measure of the difference between the image data and the statistical atlas.

29. A computer program product comprising computer readable instructions that are executable by a computer to:
acquire a plurality of sets of image data, each set of image data being from a respective subject and being representative of the image of that subject at a plurality of locations;
determine, for each set of image data, a plurality of image parameters for each location; and
perform an atlas mapping procedure for each set of image data, comprising mapping each set of image data to the atlas, and updating the atlas with the mapped image data,
wherein for each set of image data the atlas mapping procedure comprises minimising a measure of multivariate statistical distance between the set of image data and the atlas.
